(19) United States
(12) Patent Application Publication
(10) Pub. No.: US 2010/0299271 A1
(43) Pub. Date: Nov. 25, 2010

(54) METHODS AND SYSTEMS FOR PERFORMING TRANSACTIONS

(75) Inventor: Balakrishnan Satyamurti, Sharon, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Stellar Netcom, Inc., Sharon, MA (US)

(21) Appl. No.: 12/863,901

(22) PCT Filed: Jan. 21, 2009
(86) PCT No.: PCT/US09/31563

§ 371 Date: Jul. 21, 2010

Related U.S. Application Data
(60) Provisional application No. 61/022,641, filed on Jan. 22, 2008.

(51) Int. Cl. G06Q 30/00

(52) U.S. Cl. 705/80

(57) ABSTRACT

A method and system are provided for using an electronic communication system such as a computer or computer network (e.g., the internet or world wide web, an intranet, LAN or WAN, cellular or mobile telephone, or an audio or visual conferencing system) to perform a transaction between one or more buyers, one of whom acts as a moderator, and at least one seller. A moderator creates a group organized for purchasing a product/service from one or more sellers. A moderator may invite one or more sellers to offer a product/service at a given price, and the moderator may review and potentially forward to the buying group offers to sell from other sellers. When multiple buyers are interested in buying from one or more sellers, opinions of the multiple buyers are considered when the group determines to accept a seller's offer or negotiate with the seller. The moderator may provide seller's offering price and other information to other sellers such that the other sellers submit competing offers.

### RELATED APPLICATIONS

This application claims the benefit of priority to U.S. Provisional Patent Application Ser. No. 61/022,641, filed Jan. 22, 2008; which is hereby incorporated by reference in its entirety.

### FIELD OF INVENTION

This invention is concerned with a business process and a method for creating and managing purchasing groups using electronic communications systems such as the world wide web.

### BACKGROUND

Group buying models have been in vogue for many years. There have been many products available on the internet. Group buying is often targeted toward buyers with low bargaining power—individual consumers or small to medium-sized businesses.

The mechanism works through a process of demand aggregation wherein buyers commit to purchase quantities subject to certain price ceilings. Should the consortium succeed in procuring the quantities at or below these price ceilings, buyers are then obliged to follow through on their commitments. There have been many variants to this basic model.

The seller, generally, acts as a group buying operator and is ready to lower prices if he/she can get a minimum number of buyers to agree to buy the product. In this model the seller offers a price-quantity schedule. The buyers bid on seller's products and as the number of bids increase the price drops. The web portal negotiates the price breaks in advance.

Another variation of this model involves buyers making a conditional offer should the price level reach pre designated levels. The buyers are then obliged to honor their commitment.

The various models in existence during the dotcom boom included:
1. actBIG.com—The site had a “fill or kill” approach. For instance, a certain deal may offer a $200 cell phone/service package for just $20 if customers respond at a certain time. They must then commit to the sale with a credit card number on the actBIG.com site. If the deal goes through actBIG.com forwards the credit information to the vendor who handles fulfillment.
2. CoShopper.com—It provides Internet-based demand aggregation services that combine the purchasing power of individual and small business buyers, and drive down the prices of a range of name-brand products.
3. C-Tribe.com—C-Tribe.com featured discounted gift certificates for a variety of retail chains, including KB Toys and Foot Locker, as well as restaurants such as Chili's. Depending on the number of buyers, discounts could be as deep as 20 percent.
4. DemandLine.com—Demandline.com was an online marketplace providing business-to-business e-commerce for purchasing core business services.
5. LetsBuyIt.com—LetsBuyit.com introduced “group buying” (or power shopping) to the European market. The approach was similar to US-based competitors Accompany.com and Mercata. LetsBuyit.com was quickly rolled out to 14 countries, making it the world's fastest international launch of its time. The company negotiated discounts with suppliers or manufacturers which were proportional to the number of buyers it could attract on its site. Items were posted for sale with a price which reduced over a buying period as the number of users who chose the same item increased.
6. Mobshop—MobShop allows individuals to group together to make purchases, driving down the prices based on higher volumes. The unique feature was that for each product, the price will continue to fall as more and more people ‘sign up’ to purchase it.
7. Online Choice—Here, visitors register to join “buying pools,” or groups of people interested in goods and services such as electricity, natural gas, or communication services. The company presents these buying pools of customers to selected companies willing to offer discounted prices to a large group of people. The buying pool registration service is free and customers are under no obligation to accept an offer for a product or service.
8. PointSpeed—PointSpeed, Inc. provided small businesses streamline their operations with online purchasing. PointSpeed powered online Business Purchasing Centers on the web sites of leading corporations, enabling their small business customers to enjoy the level of discounts, selection and service previously available only to large corporations.
9. Shop2gether—Shop2gether.com, a U.S. company, classified itself as a Collective Purchasing Exchange, where small businesses and individuals are able to pool their purchases together to receive volume discounts. Generally, product categories include office furniture, supplies, business gifts and employee benefit services.
10. VolumeBuy—Buyers pool their purchases together to maximize their purchasing power and receive large volume discounts.

Alan Davis's presentation at a University of Minnesota Seminar (misnc.umn.edu/seminars/slides/031006.pdf) addresses group buying models. A scholarly analysis of the Group Buying models is presented by Kauffman and Wang in their paper: The (R)evolution Goes Mobile,” 5th Annual University of Minnesota Electronic Commerce Conference, Mar. 27-28, 2001, Carlson School of Management, University of Minnesota, Minneapolis, Minn. (http://misrc.umn.edu/wpaper/WorkingPapers/kw_echandbook_{—}51601.pdf)

### BRIEF DESCRIPTION OF THE DRAWINGS

FIG. 1 depicts a flowchart illustrating an overview of the consumer buying cycle.

FIG. 2 depicts a flowchart illustrating an embodiment of the present invention.

FIG. 3 depicts a flowchart illustrating an embodiment of the present invention.

FIG. 4 depicts a flowchart illustrating an embodiment of the present invention.

### DETAILED DESCRIPTION

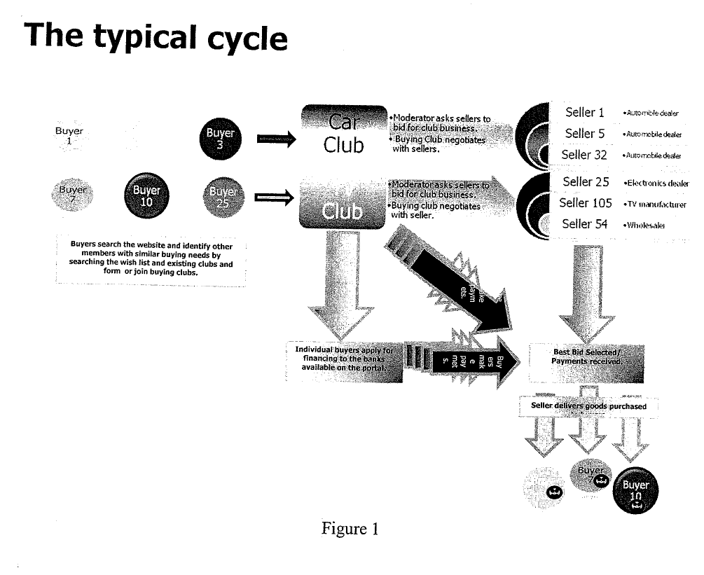

Overview: A typical buying cycle overview is illustrated in FIG. 1. Several buyers seeking to buy either a specific car model (e.g., Ford Focus or Toyota Camry) or a 42″ flat panel LCD TV get together on the website to form a Car Club A or a TV Club A. The first buyer to enter the portal usually becomes the moderator of the respective club. Buyers post their preferences for the car or TV they desire, and the moderator then asks various sellers (contact list available on the portal) to bid for the respective club's business. Once the bids are received, the moderator takes the lead role, solicits opinions from the club members and proceeds to negotiate with the sellers, if the need arises. The best bid is then selected. At this time, the buyers have the option of arranging for payments themselves or apply to the various banks/lending institutions available on the portal. Once payments are received, seller delivers goods. Any electronic communications system can be used, such as a computer or computer network (e.g., the internet or world wide web, an intranet, LAN or WAN, cellular or mobile telephones, or an audio or visual conferencing system).

All communication between the club and sellers is copied to all buyers and information on prices quoted to each buyer is available for viewing by other club members. After the elapse of a specified time period, members discuss bids using the forum facility provided by the portal. If there is no unanimous approval, a voting process is conducted. When the majority or other number of members approve a particular seller's bid, all members have either the choice of accepting the majority decision or removing themselves from the further transactions. It may happen that a particular seller's bid may not be the lowest, but the members may like this seller for various other reasons—e.g., on-time delivery, excellent customer service, or other reasons. In that event, the moderator may be requested to negotiate with that seller for a better price. Once a seller's bid is accepted, buyers arrange for payment either through the portal's financing institutions or on their own. When the payment is made and goods are delivered, the transaction is completed. Buyers then rate the sellers and the portal rates the sellers based on their payment record.

### EXAMPLES

### Example 1

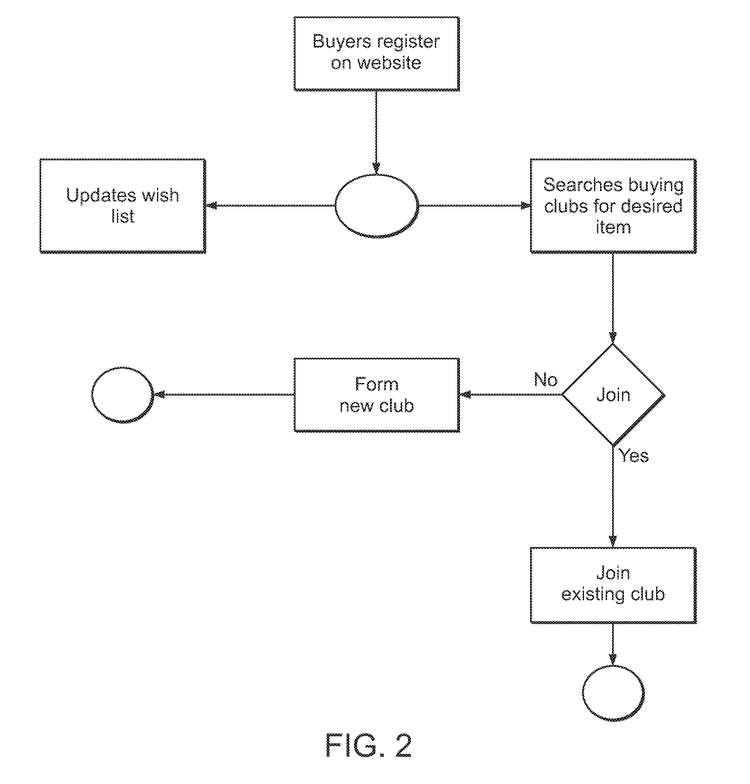

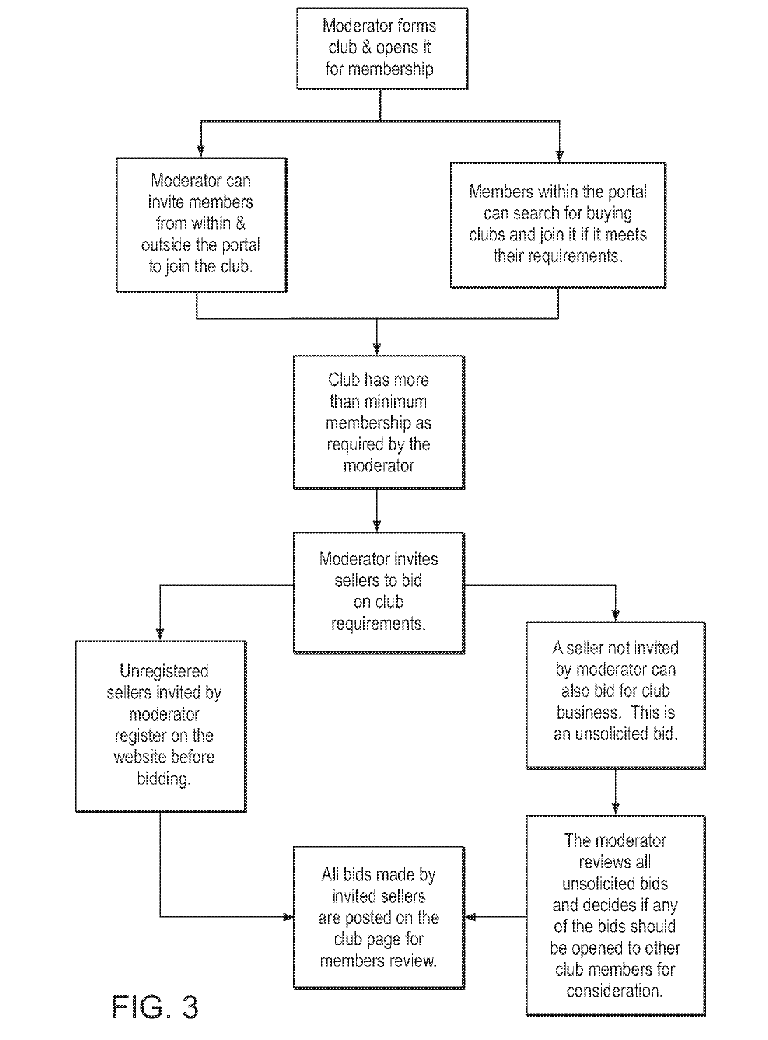

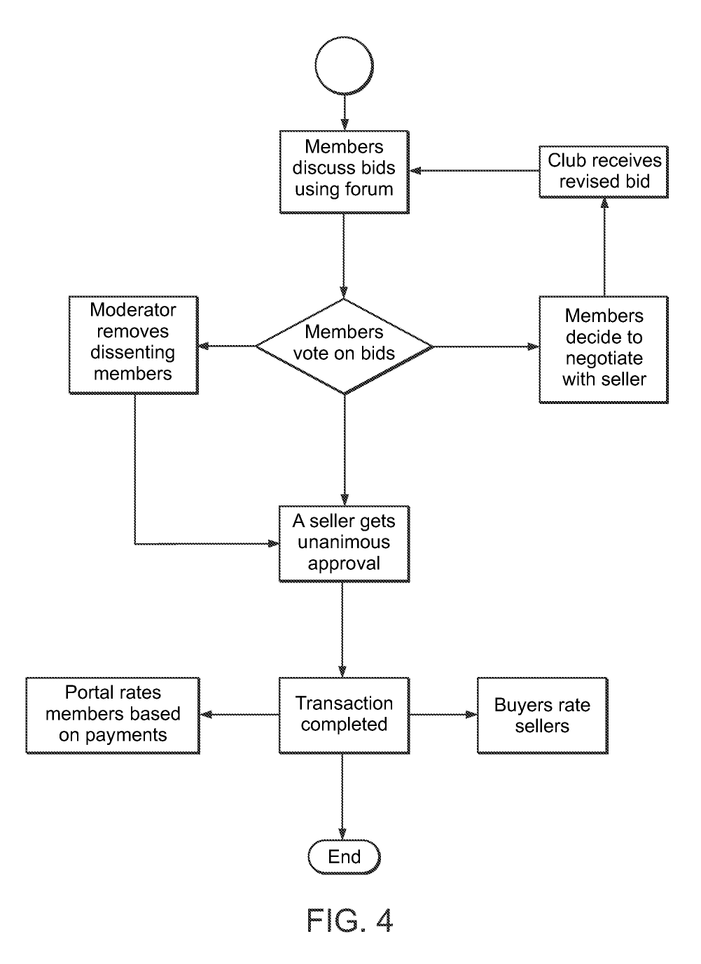

The details of this process are illustrated in FIGS. 2-4. When a buyer is looking to buy an item or service enters website thebuyersNET.com, he or she is first registered as a buyer. The buyer then searches the existing buying clubs to find a match for the item desired by the buyer. If a suitable match is found, the buyer then joins that club. If there are no matching clubs then the buyer has two options—he or she can form a new club or enter his/her name on the wish list provided at the home page of the portal. If the buyer decides to form a new club, he or she becomes the moderator. At this point, the moderator can invite members from the portal (using the wish list) or solicit other prospective buyers to join the club. Once the club has reached a minimum required membership (size may be determined by the moderator), the moderator contacts one or more sellers to bid for the specified item. The moderator can request un-registered sellers to bid for the item but the portal requires those sellers to first register their business at the website. By the same means, a registered seller not invited by the moderator can also bid for any club's business. Bids of invited sellers are automatically made available to all the club members for review. Unsolicited bids are reviewed by the moderator and made available to the members at the moderator's discretion.

### Example 2

The clubs can be either private or public (searchable by other members). A buyer may form a club that is open only by invitation to other buyers. Other members can join the club only at the discretion of the moderator. Such clubs are called private clubs. These private buying clubs essentially function similarly to the example above in all other aspects.

### Example 3

Individuals can also form their own clubs for buying multiple items. For example a buyer who has just bought a home may need to buy a refrigerator, a television, a washer dryer, a lawn mower, etc. The buyer forms a club and lists all the desired items and negotiates a deal with a prospective seller. These buying clubs essentially function similarly to the example above in all other aspects.

What is claimed is:

1. A method for using an electronic communication system to perform a transaction, comprising:
receiving into the system a first request to purchase a product or service by a first buyer;
receiving into the system a second request to purchase the product or service by one or more additional buyers;
receiving into the system instructions from the first buyer to send a first invitation to offer for sale the product or service to one or more sellers;
sending the first invitation to offer to one or more sellers;
receiving into the system a first offer sent by one or more sellers;
receiving purchase authorization to accept the offer and purchase the product or service from the first or one or more additional buyers; and
sending the purchase authorization to a selected seller.

2. The method of claim 1, wherein the first buyer sends from the system an invitation to the one or more additional buyers to send the request to purchase the product or service.

3. The method of claim 1, wherein the one or more additional buyers send the request to purchase after identifying the first buyer on the system.

4. The method of claim 1, wherein the first buyer and the one or more additional buyers form a purchasing group.

5. The method of claim 1, wherein the seller who sends the offer is not an invited seller.

6. The method of claim 1, wherein the first buyer reviews the first offer and optionally communicates the first offer to the one or more additional buyers.

7. The method of claim 1, further comprising the step of negotiating one or more terms of the offer.

8. The method of claim 7, wherein the step of negotiating one more terms comprises sending a second invitation to offer to one or more sellers and receiving a second offer sent by a seller.

9. The method of claim 8, wherein the second invitation to offer comprises information regarding the first offer sent by a seller.

10. The method of claim 8, wherein the second offer is sent by a different seller than the first offer.

11. The method of claim 7, wherein the one or more terms are price, delivery cost, delivery time, warranty, or any other negotiable term of the contract.

12. The method of claim 1, wherein the purchase authorization is sent to a seller that sent a first offer.

13. The method of claim 5, wherein the first buyer reviews the first offer and optionally communicates the first offer to the one or more additional buyers.

14. The method of claim 4, wherein the purchasing group comprises a minimum number of buyers, and wherein the minimum number of buyers is determined by the first buyer.

15. The method of claim 1, further comprising the step of sending the first offer to a purchasing group comprising the first and the one or more additional buyers.

16. The method of claim 15, further comprising the steps of receiving from at least two buyers in the purchasing group opinions on the first offer and sending the received opinions to the purchasing group.

17. The method of claim 16, wherein the step of sending the received opinions comprises posting the opinions on a message board accessible to all members of the purchasing group.

18. The method of claim 16, wherein the purchasing group makes a decision on the first offer based on the received opinions.

19. The method of claim 16, wherein the opinions comprise yes or no votes.

20. The method of claim 19, wherein a majority of opinions received from buyers comprise yes votes.

21. The method of claim 19, wherein purchase authorization is obtained only from buyers who send a yes vote.

22. The method of claim 1, further comprising the steps of:
sending two or more first offers sent by two or more sellers to a purchasing group comprising three or more buyers;
receiving from one or more buyers in the purchasing group a yes vote on the first offer from one seller, wherein the selected seller is the seller receiving more yes votes than any other seller that sent an offer.

23. The method of claim 2, wherein only buyers invited by the first buyer can send a request to purchase the product or service.

24. A method for using an electronic communication system to perform a transaction, comprising:
receiving into the system a first request to purchase two or more products by a buyer;
receiving into the system instructions from the first buyer to send a first invitation to offer for sale the products to one or more sellers;
sending the first invitation to offer to one or more sellers;
receiving into the system a first offer sent by one or more sellers;
receiving purchase authorization to accept the offer and purchase the products from the first buyer; and
sending the purchase authorization to a selected seller.

25. The method of claim 24, wherein the first offer comprises a price discount on the purchase of two or more products as compared to the price of the two or more products if purchased separately.
